(19) United States
(12) Patent Application Publication
(10) Pub. No.: US 2023/0228933 A1
(43) Pub. Date: Jul. 20, 2023

(54) DISPLAY MODULE, BACKLIGHT MODULE AND HIGH-GAIN LIGHT GUIDE PLATE

(71) Applicant: Darwin Precisions Corporation, Hsinchu County (TW)

(72) Inventors: MENG-HUI CHEN, Hsinchu County (TW); YA-FANG HUANG, Hsinchu County (TW); YU-HENG LEE, Hsinchu County (TW)

(21) Appl. No.: 18/082,800

(22) Filed: Dec. 16, 2022

(30) Foreign Application Priority Data
Jan. 17, 2022 (TW) 111101888
Jan. 28, 2022 (TW) 111104136

(51) Int. Cl. F21V 8/00

(52) U.S. Cl. CPC G02B 6/0036; G02B 6/0016

(57) ABSTRACT

A light guide plate has a light-incident end and a bottom surface. The bottom surface has a near-light source region and a visible region. The near-light source region is closer to the light-incident end than the visible region. The near-light source region includes a plurality of first microstructures, and at least part of the first microstructures is recessed on the bottom surface and has an inner concave surface. The inner concave surface has a plurality of annular structures concave or convex with respect to the inner concave surface. The annular structures are distributed at interval on the inner concave surface along a concave direction of the first microstructure.

### CROSS-REFERENCE TO RELATED APPLICATION

This application claims the priority benefits of Taiwan patent application serial no. 111104136 filed on Jan. 28, 2022 and Taiwan patent application serial no. 111101888 filed on Jan. 17, 2022. The entirety of the mentioned above patent applications are hereby incorporated by reference herein and made a part of this specification.

### BACKGROUND OF THE INVENTION

### 1. Field of the Invention

The present invention relates to a light guide plate. Particularly, the present invention relates to a high-gain light guide plate, and a backlight module and a display module including the high-gain light guide plate.

### 2. Description of the Prior Art

Backlight modules have been widely used in various display modules as backlight sources for such devices. In order to promote or improve luminous efficiency or optical properties, the backlight module may selectively include various optical components or optical films. Among those optical components or optical films, the light guide plate configured to effectively transmit and distribute light to form a surface light source is an indispensable core component of the backlight module, and the properties of the light guide plate can largely determine the luminance and luminous efficiency of the backlight module.

In order to effectively guide light emitted from the light guide plate to generate a high-luminance light source, a plurality of optical microstructures may be formed in the light guide plate. However, the conventional high-luminance light guide plate causes excessive concentration of light in the region close to the light source, resulting in a phenomenon of strong bright-dark contrast, which is called a hot spot. In other words, when the light is incident on the near-light source region of the light guide plate, the optical microstructures on the light guide plate will produce more concentrated reflected light of a smaller reflection angle, so that the dark regions at the left and right sides of the light guide plate have more serious hotspot. In addition, the concave configuration of the optical microstructures on some traditional light guide plates may make the light guide plate and the reflective sheet in contact therewith more likely generate electrostatic adsorption, resulting in a difference in brightness and darkness.

### SUMMARY OF THE INVENTION

In order to solve the above problems, an embodiment of the present invention provides a light guide plate having a light-incident end, the bottom surface of the light guide plate has a near-light source region and a visible region, and the near-light source region is closer to the light-incident end than the visible region. The near-light source region includes a plurality of first microstructures, and at least part of the first microstructures is concave in the bottom surface and have an inner concave surface. The inner concave surface has a plurality of annular structures, and the annular structures are concave or convex with respect to the inner concave surface and distributed at interval on the inner concave surface along a concave direction of the first microstructure.

An embodiment of the present invention also provides a backlight module including the aforementioned light guide plate.

An embodiment of the present invention also provides a display module including the aforementioned backlight to generate a backlight, and includes a display panel disposed opposite to the backlight module to receive the backlight.

According to the light guide plate provided by an embodiment of the present invention, the light incident into the light guide plate can be uniformly reflected by the annular structures of the first microstructure, so as to reduce the phenomenon of obvious bright-dark contrast of the light guide plate in the near-light source region. In addition, with the first microstructures of the light guide plate, the contact area between the light guide plate and the reflection sheet can be reduced, and the bright-dark difference caused by electrostatic adsorption can be reduced.

### BRIEF DESCRIPTION OF THE DRAWINGS

In order to make the above-mentioned and other purposes, features, advantages and embodiments of the present invention more clearly understood, the accompanying drawings are described as follows:

FIG. 1A is a schematic cross-sectional view of a backlight module having first microstructures and second microstructures according to an embodiment of the present invention.

FIG. 1B is a schematic bottom view of the first microstructure according to an embodiment of the present invention.

FIG. 1C is a schematic cross-sectional view of the first microstructure according to an embodiment of the present invention.

FIG. 2 is a schematic cross-sectional view of an optical path of an incident light of a backlight module according to an embodiment of the present invention.

FIG. 3A is a schematic bottom view of the second microstructure according to an embodiment of the present invention.

FIG. 3B is a schematic cross-sectional view of the second microstructure according to an embodiment of the present invention.

FIG. 4A is a schematic top view of a first arrangement of the first microstructures according to an embodiment of the present invention.

FIG. 4B is a schematic top view of a second arrangement of the first microstructures according to an embodiment of the present invention.

FIG. 5A is a schematic diagram of the supplemental distribution of the second microstructures at corners according to an embodiment of the present invention.

FIG. 5B is a schematic diagram of the local supplemental distribution of the second microstructures according to an embodiment of the present invention.

FIG. 5C is a schematic diagram of the uniformly supplemental distribution of the second microstructures according to an embodiment of the present invention.

FIG. 6 is a schematic diagram of a display module including a backlight module with the first microstructures and the second microstructures according to an embodiment of the present invention.

FIG. 7A is a schematic diagram of luminance values of a comparative embodiment without the first microstructure and the second microstructure.

FIG. 7B is a schematic diagram of luminance values of an embodiment with the first microstructures and the second microstructures.

### DETAILED DESCRIPTION OF THE PREFERRED EMBODIMENT

Various embodiments will be described in the specification, and a person having ordinary skill in the art can easily understand the spirit and the principles of the present invention by referring the specification and the drawings. Here, each element or part shown in each drawing may be exaggerated or changed for clarity. Therefore, a person having ordinary skill in the art should understand that the size and relative ratio of each element or part shown in the drawings are not the actual size and relative ratio of the actual element or part. Additionally, although some specific embodiments have been described in detail herein, these embodiments are intended to be illustrative only and are not to be considered in a limiting or exhaustive sense in all respects. Therefore, various changes and modifications to the present invention should be apparent to and can be easily accomplished by a person having ordinary skilled in the art without departing from the spirit and principles of the present invention.

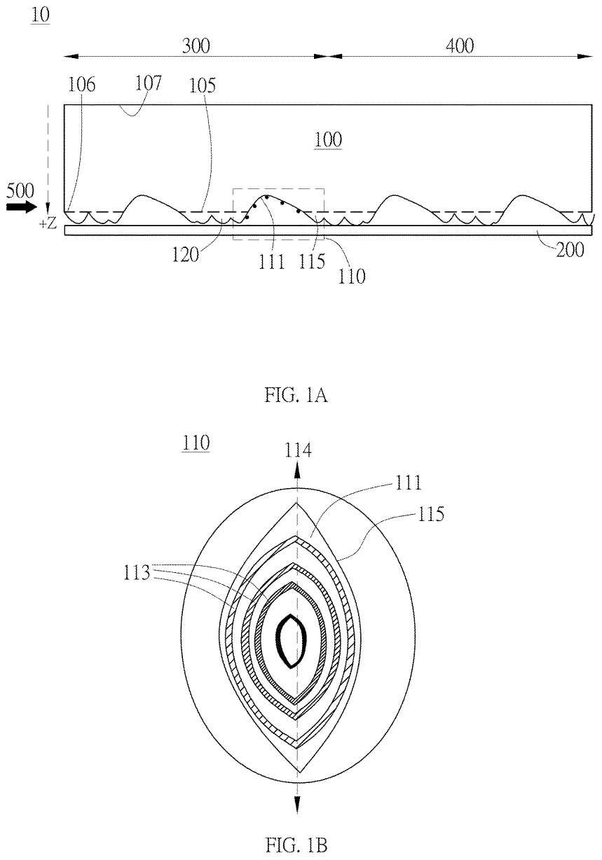

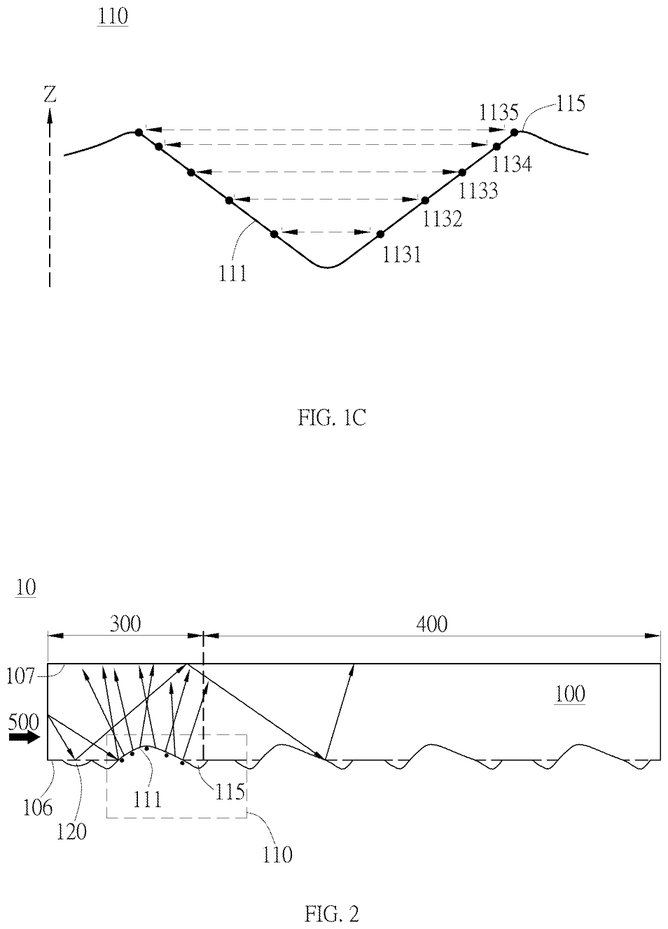

Referring to FIG. 1A, a schematic cross-sectional view of a backlight module having first microstructures and second microstructures according to an embodiment of the present invention is illustrated. As shown in the FIG. 1, the bottom surface 105 (i.e., a surface close to the reflection sheet 200 in the +Z direction of FIG. 1) of the light guide plate 100 in the backlight module 10 has a plurality of first microstructures 110 and a plurality of second microstructures 120, which are located on the near-light source region 300 defined in the bottom surface 105. In addition, the light guide plate 100 has a light-incident end 106 configured to receive the light 500 generated by the light source (not shown). That is, after the light 500 generated by the light source is incident on the light guide plate 100, the light 500 passes through the light-incident end 106 and the near-light source region 300 in sequence, and then reaches the visible region 400 (i.e., the near-light source region 300 is closer to the light-incident end 106 than the visible region 400).

Referring to FIG. 1A and FIG. 1B, FIG. 1B is a schematic bottom view of the first microstructure according to an embodiment of the present invention, and FIG. 1C is a schematic cross-sectional view of the first microstructure according to an embodiment of the present invention. As shown in FIG. 1A to FIG. 1C, each of the first microstructures 110 is at least partially concave in the bottom surface 105 and has an inner concave surface 111. The first microstructure 110 on the bottom surface 105 of the light guide plate 100 has a plurality of annular structures 113, which can be concave or convex with respect to the inner concave surface 111. It should be noted that FIG. 1A is a schematic cross-sectional view, the annular structures 113 are represented by exemplary convex dots, and the annular structures 113 will be described below.

FIG. 1C is a cross-sectional view of FIG. 1B taken along the first direction 114. The directions indicated by the double-arrow dotted lines in FIG. 1C may correspond to the first direction 114 in FIG. 1B. For example, the position of the innermost annular structure 113 shown in FIG. 1B corresponds to the two positions of the annular structure 1131 indicated by the double-arrow dotted line shown in FIG. 1C.

For the convenience of description, the concave direction of the inner concave surface 111 of the first microstructure 110 shown in FIG. 1C is opposite to the concave direction of the inner concave surface 111 shown in FIG. 1A. That is, FIG. 1C is a schematic diagram of the light guide plate 100 after flipping up and down. The concave depth of the inner concave surface 111 of the first microstructure 110 on the bottom surface 105 of the light guide plate 100 may be much greater than the dimension of the annular structures 113 of the first microstructure 110 concave or convex with respect to the inner concave surface 111. In other words, the size (e.g. depth, diameter, or width) of the annular structures 1131, 1132, 1133, 1134 and 1135 in the inner concave surface 111 is much smaller than the concave depth of the entire inner concave surface 111. For example, the size of the annular structures 113 is only one over several tenths to one percent of the entire depth of the inner concave surface 111.

According to an embodiment of the present invention, for example, the geometric properties such as the appearance or shape of the annular structures 113 may be distributed concentrically symmetrically when the annular structures 113 is a circle, but not limited to such a geometric structure. The annular structures 113 can be modified according to the desired improvement degree of the bright-dark contrast generated by the light guide plate 100 in the near-light source region 300. Alternatively, the annular structures 113 can be elliptical, football-shaped or even irregular. The inner annular structure 113 of the annular structures 113 encloses a smaller area, while the outer annular structure 113 of the annular structures 113 encloses a greater area. That is, the inner the annular structure 113 is, the smaller the area enclosed thereby is; the outer the annular structure is, the larger the area enclosed thereby is. The annular structures 113 are distributed at interval along the concave direction (e.g. the direction Z), and it can be seen from FIG. 1B that the outer annular structures 113 are distributed to wrap around the inner annular structures 113.

According to an embodiment of the present invention, the properties such as the distribution of the annular structures 113 in the inner concave surface 111 can also be modified according to the desired improvement of the bright-dark contrast generated by the light guide plate 100 in the near-light source region 300. For example, the distance (or interval) between the inner annular structures 113 can be greater, and the distance (or interval) between the outer annular structures 113 can be smaller. In other words, the distance (or interval) between the annular structures 113 can be gradually reduced from the inner side to the outer side, and the variation range can be, for example, between several micrometers, but not limited thereto. Likewise, the number of the annular structures 113 is also one adjustable parameter for the desired improvement of the bright-dark contrast generated in the near-light source region 300, and the number of the annular structures 113 is not particularly limited.

According to an embodiment of the present invention, the distance between the annular structures 113 in the inner concave surface 111 can also be modified according to the location of the first microstructures 110 in the near-light source region 300. For example, when the first microstructure 110 in the near-light source region 300 is located closer to the light-incident end 106, the average distance between the annular structures 113 thereon may be smaller. In other words, the average distance between the annular structures 113 is greater when the first microstructure 110 is farther from the light-incident end 106, and the average distance between the annular structures 113 is smaller when the first microstructure 110 is closer to the light-incident end 106.

Referring to FIG. 1A to FIG. 1C, the first microstructure 110 may further include a convex portion 115 at the edge. In other words, the edge of the first structures 110 on the bottom surface of the light guide plate 100 protrudes along the +Z direction as shown in FIG. 1A. The first microstructures 110 may be disposed on the bottom surface of the light guide plate 100 at different intervals (i.e., different densities), and the second microstructures 120 may be disposed between adjacent first microstructures 110 as shown in FIG. 1A. The second microstructures 120 may be convex portions on the bottom surface of the light guide plate 100 along the +Z direction in FIG. 1A, and the second microstructures 120 may be disposed between the first microstructures 110 with different distribution densities.

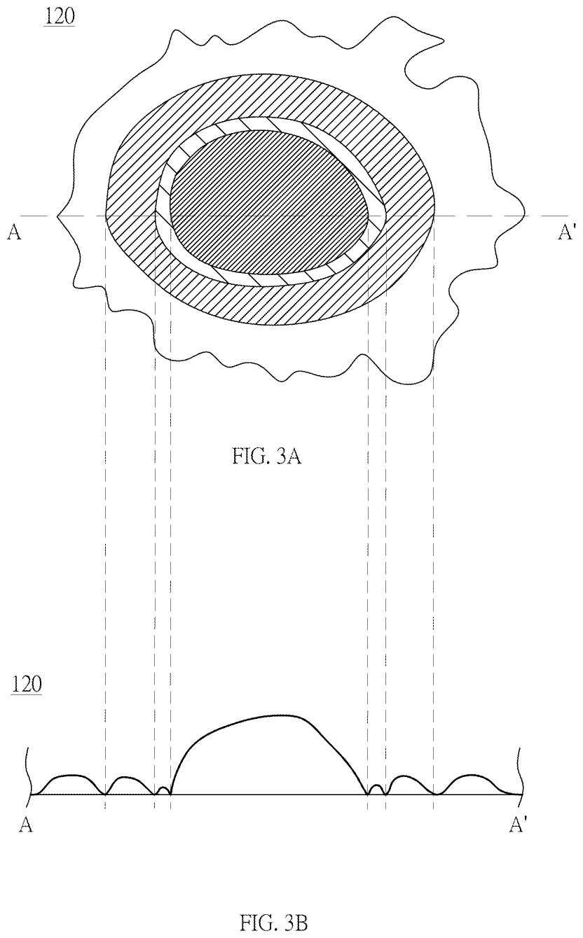

Referring to FIG. 2, it illustrates a schematic diagram of an optical path of an incident light of a backlight module according to an embodiment of the present invention. As shown in FIG. 2, when the light 500 generated by the light source enters the light guide plate 100 from the light-incident end 106, the light will be reflected to the top surface 107 of the light guide plate 100 by the first microstructures 110 and the second microstructures 120 on the bottom surface 105 in the near-light source region 300 of the light guide plate 100. In other words, after the light enters the light guide plate 100, various different reflection angles will be produced due to the annular structures 113 of the first microstructures 110, the convex portion 115 at the edge of the first microstructures 110 and the outer convex surface of the second microstructure 120. Since the aforementioned structures are not uniform structures, when the light 500 emitted by the light source encounters these microstructures, the light is incident on these microstructures at various different incident angles. Therefore, when the light is reflected from the aforementioned structures, the light is reflected to the top surface 107 of the light guide plate 100 at various reflected angles, as shown in FIG. 2. Therefore, the light reflected to the top surface 107 is not concentrated on a specific region, and the phenomenon of bright-dark contrast (i.e., hot spot) is less likely to occur.

From the above descriptions, when the light 500 of the light source is incident on the light guide plate 100, a uniform distribution will be generated on the top surface 107 of the light guide plate 100, so that the light emitted from the top surface 107 of the light guide plate 100 is suitable as a uniform backlight source, and the phenomenon of strong bright-dark contrast will not be generated on the top surface 107 due to the structural properties of the light guide plate 100. Furthermore, due to the structures such as the convex portion 115 at the edge of the first microstructures 110 and the outer convex surface of the second microstructures 120, the contact area between the light guide plate 100 and the optical elements (such as the reflection sheet 200) disposed on one side of the bottom surface 105 of the light guide plate 100 is reduced, which further reduces the electrostatic adsorption phenomenon between the light guide plate 100 and the reflection sheet 200. Therefore, the improvement of the electrostatic adsorption phenomenon between the light guide plate 100 and the reflection sheet 200 also reduces the light-dark contrast phenomenon of the near-light source area 300 in the light guide plate 100, thereby obtaining a better visual effect.

Embodiments of the second microstructures 120 are further described below.

Referring to FIG. 3A and FIG. 3B, FIG. 3A is a schematic bottom view of the second microstructure according to an embodiment of the present invention, and FIG. 3B is a schematic cross-sectional view of the second microstructure according to an embodiment of the present invention. Preferably as light-scattering structures, the second microstructures 120 can have irregular convex surfaces as shown in FIG. 3A and FIG. 3B. In FIG. 3A, the region indicated by the denser oblique lines is the region with a relatively large degree of convexity, and the region indicated by the sparser oblique lines is the region with a relatively small degree of convexity. When the light 500 of the light source reaches the second microstructures 120, the reflected light with different reflection angles can be generated by the second microstructures 120, so that the relatively uniform reflected light will be generated on the top surface 107 of the light guide plate 100 without obvious bright-dark contrast phenomenon. In addition, due to the irregular shape of the second microstructures 120, when the light 500 of the light source is incident on the second microstructure 120, the light will also be reflected to the reflection sheet 200 first, and then reflected to the top surface 107 of the light guide plate 100 via secondary reflection, further improving the bright-dark contrast phenomenon in the near-light source region 300.

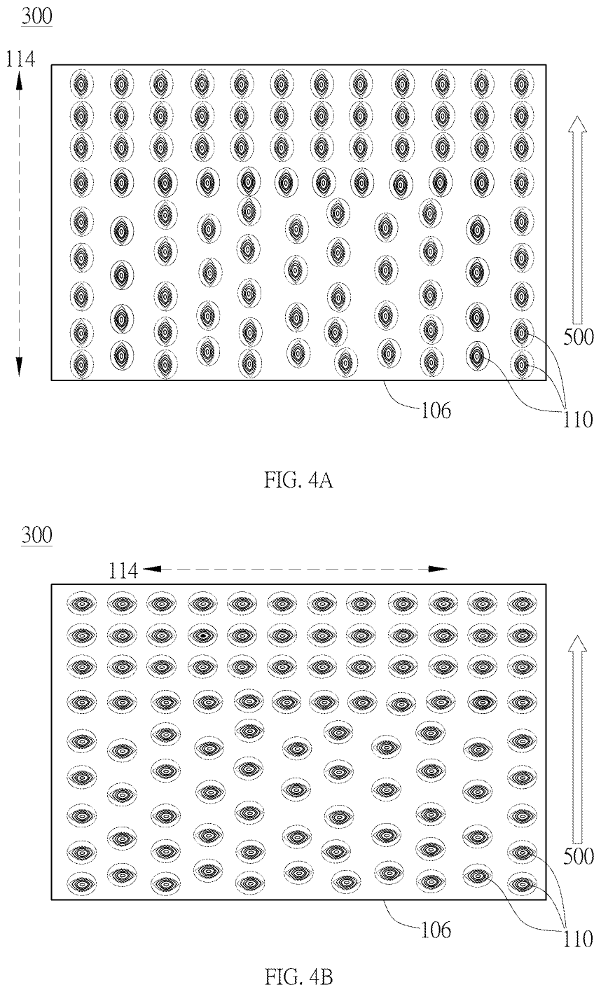

Referring to FIG. 4A, which is a schematic top view of a first arrangement of the first microstructures according to an embodiment of the present invention. Regarding the arrangements of the first microstructures 110 on the bottom surface of the light guide plate 100, various arrangements are possible. In an embodiment, the annular structures 113 of the first microstructures 110 can be arranged with the first direction 114 parallel to the incident (or propagation) direction of the light source 500, as shown in FIG. 4A. For example, the first direction 114 may be the direction with the longer size of the elliptical or football-shaped annular structures 113, namely the direction of the long axis, as shown in FIG. 1B. When the light generated by the light source 500 is incident into the first microstructures 110 from the light-incident end 106 along a direction parallel to the first direction 114, the light takes more time to pass through the first microstructures 110, so there is a higher probability that the light 500 of the light source will be reflected to the top surface 107 of the light guide plate 100 at various reflection angles.

Referring to FIG. 4B, which is a schematic top view of a second arrangement of the first microstructures according to an embodiment of the present invention. In this embodiment, the annular structures 113 in the elliptical or football-shaped first microstructures 110 can be arranged with the first direction 114 perpendicular to the incident (or propagation) direction of the light 500 of the light source as shown in FIG. 4B. When the light generated by the light source 500 is incident into the first microstructures 110 from the light-incident end 106 along a direction perpendicular to the first direction 114, the light takes less time to pass through the first microstructure 110, so there is a less probability that the light will be reflected to the top surface 107 of the light guide plate 100 at various angles. In other words, the arrangement of the first microstructures 110 is also one of the adjustable parameters for the desired improvement of the bright-dark contrast generated on the top surface 107.

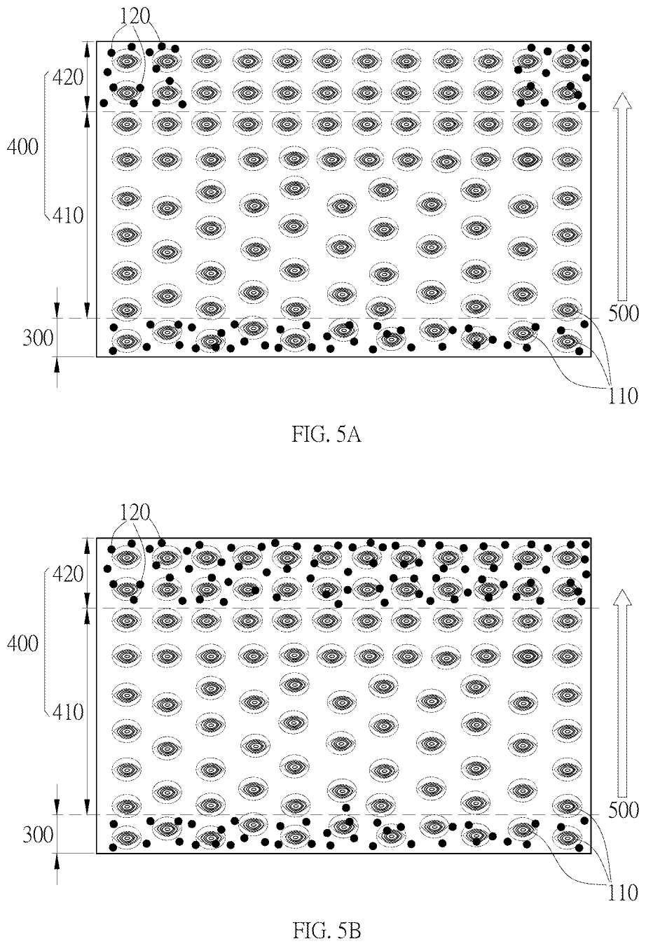

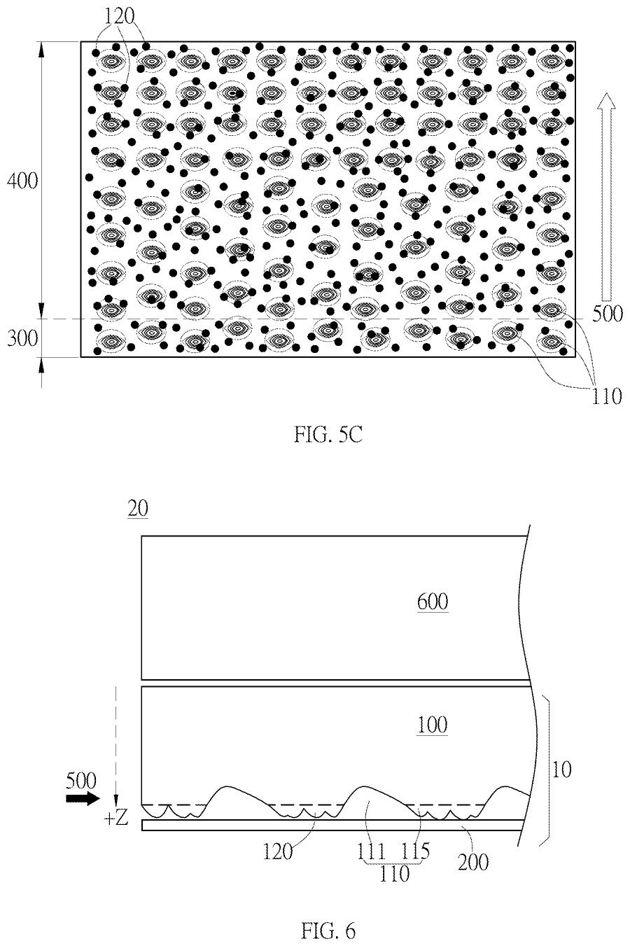

Referring to FIG. 5A to FIG. 5C, FIG. 5A is a schematic diagram of the supplemental distribution of the second microstructures at corners according to an embodiment of the present invention, and FIG. 5B is a schematic diagram of the local supplemental distribution of the second microstructures according to an embodiment of the present invention, and FIG. 5C is a schematic diagram of the uniformly supplemental distribution of the second microstructures according to an embodiment of the present invention. As shown in FIG. 5A to FIG. 5C, the aforementioned first microstructures 110 and second microstructures 120 can be disposed on the bottom surface in the visible region 400 in different ways in addition to the near-light source region 300 of the light guide plate 100. The convex portion 115 at the edge of the first microstructures 110 (as shown in FIG. 1B) may have an overlapping area with the edge of the outer convex surface of the second microstructures 120 (as shown in FIGS. 3A and 3B), particularly in the case that the second microstructures 120 are distributed between the adjacent first microstructures 110 or in the near-light source region 300 with a higher density, as shown in FIG. 5A to FIG. 5C.

For example, as shown in FIG. 5A and FIG. 5B, the first microstructures 110 may be distributed in a lower density on the first region 410 of the visible region 400, which is close to the near-light source region 300, and distributed in a higher density on the second region 420 of the visible region 400, which is away from the near-light source region 300. Alternatively, the first microstructures 110 may be distributed on the visible region 400 with a uniform density as shown in FIG. 5C. As such, the bright-dark contrast of the visible region 400 of the light guide plate 100 can also be modified by the first microstructures 110 to obtain a more uniform backlight.

Similarly, as shown in FIG. 5A, the second microstructures 120 may be disposed at corners in the second region 420 of the visible region 400, which is away from the near-light source region 300, and not disposed in the first region 410, which is close to the near-light source region 300. Furthermore, as shown in FIG. 5B, the second microstructures 120 may be uniformly disposed in the second region 420 of the visible region 400, which is away from the near-light source region 300, and not disposed in the first region 410 of the visible region 400, which is close to the near-light source region 300. Alternatively, as shown in FIG. 5C, the second microstructures 120 may be distributed in the visible region 400 with a uniform density. As such, the bright-dark contrast of the light guide plate 100 on the visible region 400 can also be modified by the second microstructures 120 to obtain a more uniform backlight.

Referring to FIG. 6, it illustrates a schematic diagram of a display module including the backlight module with first microstructures and second microstructures according to an embodiment of the present invention. As shown in FIG. 6, the light guide plate 100 having the aforementioned first microstructures 110 and the second microstructures 120 can be combined with the reflection sheet 200 to form the backlight module 10, and the backlight module 10 can be further combined with a display panel 600 to form a display module 20, which includes the display panel 600 and the backlight module 10 and has a uniform backlight.

The aforementioned first microstructures 110 and the second microstructures 120 can be formed from processing the light guide plate 100 by various processes, such as a printing process, a UV imprinting process, an etching process, or a laser process.

The results of the optical simulations are provided in Table 1 to show the relative optical properties of the light guide plate 100 with or without the first microstructures 110 and the second microstructures 120.

TABLE 1

| | Control | Condition | Condition | Condition | Condition |
|---|---|---|---|---|---|
| | group | 1 | 2 | 3 | 4 |
| First | X | X | X | X | ◯ |
| microstructure | | | | | |
| Second | X | ◯ | ◯ | ◯ | ◯ |
| microstructure | | | | | |
| Density of | X | 10% | 5% | 3% | 3% |
| second | | | | | |
| microstructure | | | | | |
| Average | 3352 | 3161 | 3292 | 3416 | 3392 |
| luminance | | | | | |
| Luminance | 100% | 94% | 98% | 102% | 101% |
| ratio | | | | | |

From the conditions 1 to 3 of the above table, when the distribution density of the second microstructures 120 increases, the overall average luminance decreases. From the condition 4, it can be known that the addition of the first microstructures 110 does not significantly affect the average luminance, and the light utilization can be maintained.

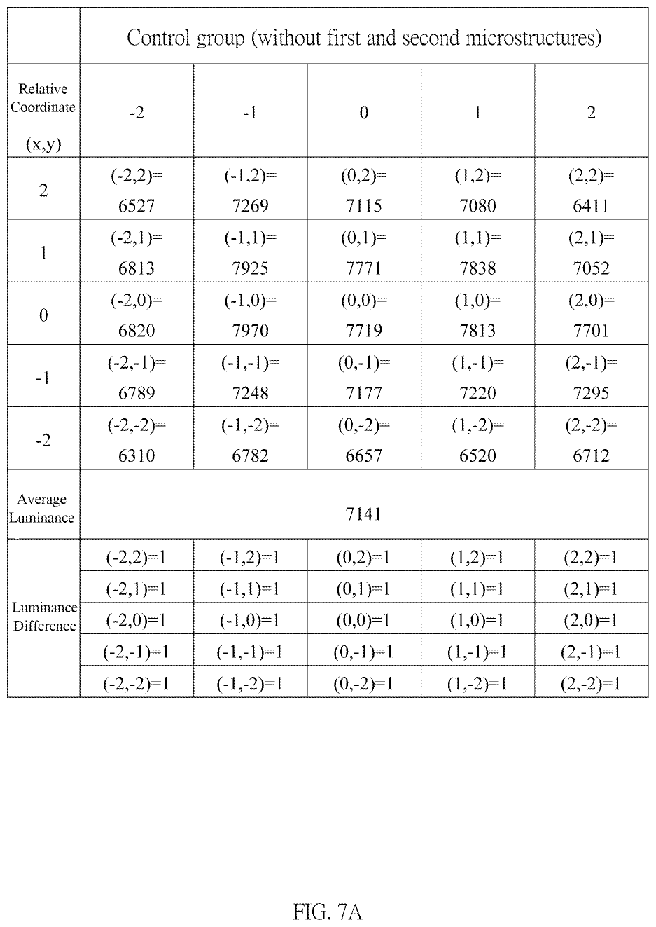

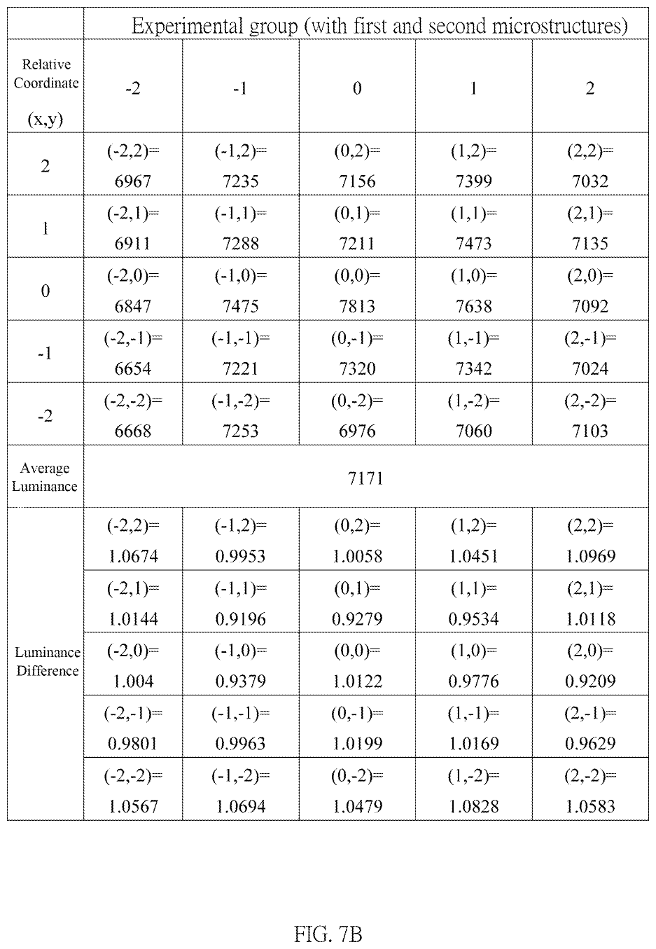

The actual experimental results are provided in FIG. 7A and FIG. 7B. The light guide plate 100 is divided into 25 regions (5×5) represented by relative coordinates (x=−2 to 2, y=−2 to 2), and the luminance is respectively measured and compared to each other by relative values.

Referring to FIG. 7A, it is a schematic diagram of luminance values of the control group (comparative embodiment) without the first microstructures and the second microstructures. As shown in FIG. 7A, the value of each relative coordinate point in FIG. 7A represents the luminance value actually measured from the light guide plate 100, which does not include the first microstructures 110 and the second microstructures 120, and the average of the measured 25 luminance values is 7141 units. It can be known from the distribution, when the position of the light guide plate 100 is close to the corner (i.e., the region close to (−2, 2), (−2, −2), (2, 2) or (2, −2)), or corresponds to the near-light source region 300 (e.g. (−2, −2), (−1, −2), (0, −2), (1, −2), or (2, −2)), the relative value is smaller, resulting in lower luminance and a more obvious bright-dark contrast.

Referring to FIG. 7B, it is a schematic diagram of luminance values of an experimental group including the first microstructures and the second microstructures according to an embodiment of the present invention. As shown in FIG. 7B, the value of each relative coordinate point in FIG. 7B represents the value of luminance actually measured from the light guide plate 100 including the first microstructures 110 and the second microstructures 120, and the average value of the 25 measured luminance values is 7171 units. In addition, the 25 luminance values actually measured from the structure that does not include the first microstructures 110 and the second microstructures 120 are taken as 1 for the comparison value of the relative luminance difference.

In other words, the 25 luminance values measured from the light guide plate 100 with the first microstructures 110 and the second microstructures 120 are compared with the 25 luminance values measured from the light guide plate 100 without the first microstructures 110 and the second microstructures 120 according to the corresponding positions. If the measured luminance value in FIG. 7B is higher than that in FIG. 7A, the value in the region representing the luminance difference is greater than 1 in FIG. 7B. On the contrary, if the measured luminance value in FIG. 7B is lower than that in FIG. 7A, the value in the region representing the luminance difference is less than 1 in FIG. 7B.

It can be seen from the FIG. 7A and FIG. 7B that the average luminance of the light guide plate 100 does not decay after the first microstructures 110 and the second microstructures 120 are added. When the position of the light guide plate 100 is close to the corner (i.e., the region close to (−2, 2), (−2, −2), (2, 2) or (2, −2)), or corresponds to the near-light source region 300 (e.g. (−2, −2), (−1, −2), (0, −2), (1, −2), or (2, −2)), the phenomenon of bright-dark contrast is obviously improved.

Although the preferred embodiments of the present invention are described herein, the above descriptions are merely illustrative. The disclosed preferred embodiments will not limit the scope of the present invention. Further modification of the invention herein disclosed will occur to a person having ordinary skill in the art and all such modifications are deemed to be within the scope of the invention as defined by the appended claims.

What is claimed is:

1. A light guide plate having a light-incident end, comprising:
a bottom surface having a near-light source region and a visible region, wherein the near-light source region is closer to the light-incident end than the visible region, wherein the near-light source region comprises:
a plurality of first microstructures, each of the first microstructures being at least partial concave in the bottom surface and having an inner concave surface;
wherein the inner concave surface has a plurality of annular structures;
the annular structures are concave or convex with respect to the inner concave surface and distributed at interval on the inner concave surface along a concave direction of the first microstructure.

2. The light guide plate of claim 1, further comprising:
a plurality of second microstructures disposed on the bottom surface of the light guide plate, and each of the second microstructures has an outer convex surface.

3. The light guide plate of claim 1, wherein each of the first microstructures further comprises a convex portion at edge; the convex portion protrudes from the bottom surface and at least partially surrounds the inner concave surface.

4. The light guide plate of claim 1, wherein the size of each of the annular structures is smaller than a depth of the inner concave surface.

5. The light guide plate of claim 1, wherein the annular structures are distributed concentrically symmetrically.

6. The light guide plate of claim 1, wherein the intervals between the annular structures are non-equidistant distributed.

7. The light guide plate of claim 1, wherein the annular structures have a long axial direction; the long axial direction is parallel to an incident direction of a light of a light source.

8. The light guide plate of claim 1, wherein the annular structures have a short axial direction; the short axial direction is parallel to an incident direction of a light of a light source.

9. The light guide plate of claim 2, wherein the edge of the first microstructures have an overlapped area with the second microstructures.

10. The light guide plate of claim 2, wherein the first microstructures and the second microstructures are further disposed on the visible region, wherein the visible region comprises a first region adjacent to the near-light source region and a second region away from the near-light source region.

11. The light guide plate of claim 10, wherein the second microstructures are distributed on the second region.

12. The light guide plate of claim 11, wherein the second microstructures are distributed at a corner of the second region.

13. The light guide plate of claim 10, wherein the second microstructures are distributed in the first region and the second region of the visible region.

14. The light guide plate of claim 10, wherein a distribution density of the first microstructures in the second region is greater than the distribution density of the first microstructures in the first region.

15. A backlight module, comprising the light guide plate of claim 1.

16. A display module, comprising:
the backlight module of claim 15 adapted to generate a backlight; and
a display panel disposed corresponding to the backlight module to receive the backlight.
